(19) United States
(12) Patent Application Publication
(10) Pub. No.: US 2012/0032647 A1
(43) Pub. Date: Feb. 9, 2012

(54) METHOD FOR DETERMINING COMPLETION OF CHARGE OF LITHIUM ION SECONDARY BATTERY, METHOD FOR DETERMINING TERMINATION OF DISCHARGE OF LITHIUM ION SECONDARY BATTERY, CHARGE CONTROL CIRCUIT, DISCHARGE CONTROL CIRCUIT, AND POWER SUPPLY

(76) Inventors: Kozo Watanabe, Osaka (JP); Toshitada Sato, Osaka (JP); Masahiro Kinoshita, Osaka (JP)

(21) Appl. No.: 13/139,115

(22) PCT Filed: Oct. 29, 2010
(86) PCT No.: PCT/JP10/06409

§ 371 Date: Jun. 10, 2011

(30) Foreign Application Priority Data
Dec. 14, 2009 (JP) 2009-282411

(51) Int. Cl. H02J 7/00; G01N 27/416

(52) U.S. Cl. 320/136; 320/149; 324/433

(57) ABSTRACT

A method for determining completion of charge of a long-duration lithium ion secondary battery is provided.

A method for determining completion of charge a lithium ion secondary battery including one lithium compound having an olivine crystal structure as a positive electrode active material, and a graphite material as a negative electrode active material, includes: (S1) charging the battery by an amount of electricity Xc in time Ti1; (S2) stopping the charging for time Yc after completion of (S1), and measuring a battery voltage Vi1 after the time Yc has passed; (S3) charging the amount of electricity Xc in the time Ti1 after completion of (S2); (S4) stopping the charging for the time Yc after completion of (S3), and measuring a battery voltage Vi2 after the time Yc has passed; and comparing Vi2−Vi1 with a predetermined voltage difference Vi3 to determine that the charge has been completed when Vi2−Vi1>Vi3, and determine that the charge has not been completed when Vi2−Vi1<Vi3.

### TECHNICAL FIELD

The present invention relates to a method for determining completion of charge of a lithium ion secondary battery, a method for determining termination of discharge of a lithium ion secondary battery, a charge control circuit, a discharge control circuit, and a power supply.

### BACKGROUND ART

Nonaqueous electrolyte secondary batteries have a high energy density, and thus are widely used as power supplies for portable electric devices, such as mobile phones and notebook computers.

Among the nonaqueous electrolyte secondary batteries, lithium ion secondary batteries have a high voltage of 3.6 V. Thus, in terms of the same power generation energy, lithium ion secondary batteries only need to be about 50% in mass, and about 20-50% in volume of nickel-metal hydride batteries. Thus, lithium ion secondary batteries have a high energy density, and it is possible to downsize the lithium ion secondary batteries. Further, lithium ion secondary batteries have no memory effect. Thus, almost all power supplies for mobile phones and notebook computer are lithium ion secondary batteries.

In general, since having no memory effect, lithium ion secondary batteries in mobile phones and notebook computers are charged during bedtime after the mobile phones and notebook computers are used during daytime, or charged when a warning is displayed that an amount of remaining electricity is small. In the case of notebook computers in particular, users strongly demand that they want to use their notebook computers for as long as possible at one charge. Thus, one of typical ways of using the notebook computers is that the notebook computers are fully charged so that they can be used outside for as long as possible.

In this case, the state of charge of the lithium ion secondary battery (a ratio of an amount of electricity accumulated (or remained) at that time to the battery capacity of the lithium ion secondary battery, hereinafter referred to as “state of charge (SOC [%])”) can be any percentage, from close to 0% to close to 100%. Since there is a strong demand from users, as described above, that they want to use their notebook computers for as long as possible at one charge, charge is controlled so that SOC is close to 100% at completion of the charge.

Further, in recent years, secondary batteries are combined with a solar battery and an electric power generating system, and are widely used as a power supply system. Such a power supply system combined with a secondary battery accumulates excess electricity in the secondary battery, and the electricity is supplied from the secondary battery when a load device requires electricity, thereby improving energy efficiency.

Further, a similar principle is used in a hybrid vehicle which uses an engine and a motor. During driving, an electric generator is actuated by excess engine output power, and a secondary battery is charged. During acceleration, a motor is activated using electricity in the secondary battery as an auxiliary power.

Almost no lithium ion secondary battery has been used so far in the above-described power supply systems and hybrid vehicles in terms of safety and cost, and nickel-metal hydride batteries have been mainly used.

### CITATION LIST

### Patent Document

Patent Document 1: Japanese Patent Publication No. 2000-78769

Patent Document 2: Japanese Patent Publication No. 2007-250299

### SUMMARY OF THE INVENTION

### Technical Problem

Recently, there is an increasing movement to use lithium ion secondary batteries in a power supply system, a hybrid vehicle, and an electric vehicle, as well, because of the high energy density characteristics of lithium ion secondary batteries. However, the lithium ion secondary batteries have not been used so far in a power supply system, a hybrid vehicle, or an electric vehicle because there are many problems in terms of safety, cost, long time use, etc. These problems need to be solved.

The present invention was made in view of the above problems, and it is an objective of the invention to provide a method for determining completion of charge of a long-duration lithium ion secondary battery, a method for determining termination of discharge of the lithium ion secondary battery, a charge control circuit, and a discharge control circuit.

### Solution to the Problem

To solve the above problems, according to the present invention, a method for determining completion of charge of a lithium ion secondary battery including one lithium compound having an olivine crystal structure as a positive electrode active material, and a graphite material as a negative electrode active material, the method including: (S1) charging the battery by an amount of electricity Xc in time Ti1; (S2) stopping the charging for time Yc after completion of (S1), and measuring a battery voltage Vi1 after the time Yc has passed; (S3) charging the battery by the amount of electricity Xc in the time Ti1 after completion of (S2); (S4) stopping the charging for the time Yc after completion of (S3), and measuring a battery voltage Vi2 after the time Yc has passed; and comparing Vi2−Vi1 with a predetermined voltage difference Vi3 to determine that the charge has been completed when Vi2−Vi1>Vi3, or determine that the charge has not been completed when Vi2−Vi1<Vi3.

It is preferable that a minimum distance between layers of carbon planes of the graphite material is equal to or smaller than 0.355 nm when it is determined that the charge has been completed.

According to the present invention, a method for determining termination of discharge of a lithium ion secondary battery including one lithium compound having an olivine crystal structure as a positive electrode active material, and a graphite material as a negative electrode active material, the method including: (P1) discharging the battery by an amount of electricity Xd in time To1; (P2) stopping the discharging for time Yd after completion of (P1), and measuring a battery voltage Vo1 after the time Yd has passed; (P3) discharging the battery by the amount of electricity Xd in the time To1 after completion of (P2); (P4) stopping the discharging for the time Yd after completion of (P3), and measuring a battery voltage Vo2 after the time Yd has passed; and comparing Vo1−Vo2 with a predetermined voltage difference Vo3 to determine that the discharge has been terminated when Vo1−Vo2>Vo3, or determine that the discharge has not been terminated when Vo1−Vo2<Vo3.

It is preferable that a minimum distance between layers of carbon planes of the graphite material is equal to or larger than 0.338 nm when it is determined that the discharge has been terminated.

According to the present invention, a charge control circuit for a lithium ion secondary battery including one lithium compound having an olivine crystal structure as a positive electrode active material, and a graphite material as a negative electrode active material, the charge control circuit including: a voltage measurement section for measuring a battery voltage; a cycle execution section for performing multiple cycles, each cycle including charge and a stop of the charge as one cycle; a voltage difference detection section for detecting a difference between a battery voltage after a stop of charge of one of the cycles and a battery voltage after a stop of charge of a cycle subsequent to the one of the cycles; a determination section for determining whether the voltage difference detected by the voltage difference detection section is larger or smaller than a set value; and a control section for stopping the charge when the voltage difference is larger than the set value, and continuing the charge when the voltage difference is smaller than the set value.

It is preferable that the control section controls the charge such that a minimum distance between layers of carbon planes of the graphite material is equal to or smaller than 0.355 nm.

According to the present invention, a discharge control circuit for a lithium ion secondary battery including one lithium compound having an olivine crystal structure as a positive electrode active material, and a graphite material as a negative electrode active material, the discharge control circuit including: a voltage measurement section for measuring a battery voltage; a cycle execution section for performing multiple cycles, each cycle including discharge and a stop of the discharge as one cycle; a voltage difference detection section for detecting a difference between a battery voltage after a stop of discharge of one of the cycles and a battery voltage after a stop of discharge of a cycle subsequent to the one of the cycles; a determination section for determining whether the voltage difference detected by the voltage difference detection section is larger or smaller than a set value; and a control section for stopping the discharge when the voltage difference is larger than the set value, and continuing the discharge when the voltage difference is smaller than the set value.

It is preferable that the control section controls the discharge such that a minimum distance between layers of carbon planes of the graphite material is equal to or larger than 0.338 nm.

A power supply according to the present invention includes: a lithium ion secondary battery including one a lithium compound having an olivine crystal structure as a positive electrode active material, and a graphite material as a negative electrode active material; and at least one of the charge control circuit or the discharge control circuit.

It is preferable that the lithium compound is any one of LiFePO₄, LiMnPO₄, LiCoPO₄, LiCuPO₄, LiNiPO₄, LiVPO₄, or a lithium compound having an olivine crystal structure in which some of transition metal elements of the LiFePO₄, LiMnPO₄, LiCoPO₄, LiCuPO₄, LiNiPO₄, LiVPO₄ are substituted with another element.

### Advantages of the Invention

According to the present invention, a range of charge and discharge of a lithium ion secondary battery can be controlled in a predetermined range with reliability, while using a positive electrode material made of an active material whose charge/discharge potential is constant.

### BRIEF DESCRIPTION OF THE DRAWINGS

FIG. 1 is a graph showing a change in voltage of a lithium ion secondary battery according to an embodiment and a change in potential of a positive electrode of LiFePO₄ in relation to SOC.

FIG. 2 is a graph showing a voltage change of a carbon-based negative electrode active material of a lithium ion secondary battery according to an embodiment in relation to SOC.

FIG. 3 is an illustrative figure for explaining a voltage change based on which a stop of charge is decided.

FIG. 4 is an illustrative figure for explaining a voltage change based on which a stop of discharge is decided.

FIG. 5 is a flow chart for showing an example operation system which decides a stop of charge.

FIG. 6 is a flow chart for showing an example operation system which decides a stop of discharge.

FIG. 7 is a block diagram for showing an example control section which decides a stop of charge and a stop of discharge.

FIG. 8 is a cross section for schematically showing a structure of a lithium ion secondary battery to which a control method according to an embodiment is applied.

FIG. 9 shows an X-ray diffraction pattern of a carbon-based active material of a negative electrode in a range of control of charge and discharge according to an embodiment.

### DESCRIPTION OF EMBODIMENTS

(Definition)

Including one lithium compound having an olivine crystal structure as a positive electrode active material means including, as a positive electrode active material, only one type of lithium compound which has an olivine crystal structure and whose potential does not change at the time of charge/discharge.

A method for determining completion of charge is a method for determining whether charge is finished or not. Specifically, charge is considered to be finished when the battery reaches a predetermined SOC.

A method for determining termination of discharge is a method for determining whether discharge is finished or not. Specifically, discharge is considered to be finished when the battery reaches a predetermined SOC.

A minimum distance between layers of carbon planes is a smallest distance among distances between two adjacent carbon planes of layered graphite crystals. Lithium is intercalated in the space between two adjacent carbon planes (the space between layers), and the distance between layers varies according to the amount of intercalated lithium per unit area of the carbon plane. The graphite material may have a plurality of different distances between layers, depending on the amount of the intercalated lithium. This means that in one graphite material, the distance between two carbon planes may be a1, for example, and the distance between different two carbon planes may be a2. The smallest one of such distances between carbon planes is called a minimum distance between layers of carbon planes.

### First Embodiment

Details of how the present invention was achieved will be described first.

In recent years, combining a secondary battery with a solar battery or an electric power generating system for utilization as a power supply system for home use or industrial use, for example, has been intensively studied. Such a power supply system combined with a secondary battery (hereinafter referred to as “secondary battery power supply system”) accumulates excess electricity in the secondary battery, and the electricity is supplied from the secondary battery when a load device requires electricity, thereby improving energy efficiency.

Further, a similar principle is used in a hybrid vehicle which uses an engine and a motor. During driving, an electric generator is actuated by excess engine output power, and a secondary battery is charged. During acceleration, a motor is activated using electricity in the secondary battery as an auxiliary power.

For this secondary battery power supply system, stable charge and discharge are necessary for as long as 10 years or more. Especially in the case of a power supply on a vehicle, stable charge and discharge, i.e., always supplying the same amount of electricity at the same voltage and accumulating electricity, is essential to ensure safety of the passengers.

However, in this secondary battery power supply system, if the secondary battery is fully charged during charge, excess electricity cannot be charged and therefore losses are produced, or it becomes impossible to ensure long-time stable charge and discharge because the secondary battery goes into overcharge and is deteriorated. These problems were not considered when secondary batteries were used as power supplies for conventional portable electric devices, because it was considered that once the battery was charged, the ability of being used for a long time was the first priority, and that if the battery was deteriorated by repeated full charge, the battery only needed to be replaced. However, in the secondary battery power supply system, it is important to detect and control the state of charge of the secondary battery. In other words, it is important to control charge and discharge so that the SOC will not be 100% at the time of charge, and that the SOC will not be 0% at the time of discharge. Furthermore, it is preferable that the charge and discharge are controlled in a smaller SOC range, e.g., 30-60%, for the sake of long-time stable battery performance.

Patent Document 1 discloses a technique of detecting an SOC of a nonaqueous electrolyte secondary battery in which, in general, to detect an SOC, a battery voltage which depends on a positive electrode potential that depends on the SOC is detected and the state of charge is detected from a relationship between an SOC memorized beforehand and the detected battery voltage. However, this technique is intended for a nickel metal hydride secondary battery, and thus may not be used for a lithium ion battery. Particularly in the case where an active material which has an olivine crystal structure and whose potential at the time of charge/discharge is flat with respect to the SOC (i.e., a potential at the time of charge/discharge does not vary even if the SOC is changed by the charge/discharge) is used as a material for the positive electrode, it is very difficult to detect the SOC using a battery voltage. Therefore, this technique cannot be used.

Patent Document 2 discloses a technique in which a lithium-containing transition metal complex oxide having a layered crystal structure is added to a positive electrode active material having an olivine crystal structure, thereby including two or more types of active materials in a positive electrode to form two or more flat portions where voltage changes are small, and transition between different flat portions is detected from a voltage change of the battery to detect the SOC. The positive electrode active material having an olivine crystal structure is superior to other positive electrode active materials in terms of cost and safety. That is why such a technique has been developed.

However, according to the technique disclosed in Patent Document 2, two or more types of positive electrode active materials need to be used to increase accuracy of detection of the SOC. Therefore, dispersion of the positive electrode active materials at the time of formation of the electrode may differ among the types of the positive electrode active materials. Further, if dispersion of the different active materials is nonuniform, variations in the state of charge locally occur. As a result, a reduction of capacity is accelerated by repeated charge and discharge.

The inventors of the present application conducted various studies to ensure stable charge and discharge by utilizing, in a secondary battery power supply system, a lithium ion battery in which only one type of positive electrode active material having an olivine crystal structure is used to make the present invention. In an example embodiment, a method was adopted in which a battery was charged or discharged by a predetermined amount of electricity; a battery voltage was measured after a predetermined period of time; these processes were performed again, and the battery voltages measured twice were compared to determine completion of charge or termination of discharge based on whether the difference between the battery voltages is larger or smaller than the predetermined value. This method does not utilize a change in potential of a positive electrode active material at the time of charge or discharge, but utilizes a phenomenon in which a distance between adjacent carbon planes of a graphite material of a negative electrode active material discontinuously varies according to an amount of insertion of lithium (i.e., SOC). The inventors of the present application are the first to focus on a change in the characteristics of the negative electrode active material in determining completion of charge or termination of discharge.

According to this determination method, a potential of a negative electrode is maintained at about 120 mV by controlling a minimum distance between layers of carbon planes of the graphite (carbon) material that is used for the negative electrode to be 0.355 nm to 0.338 nm. If the minimum distance between layers of carbon planes is smaller than 0.338 nm, the potential of the negative electrode increases by 100 mV. If the minimum distance between layers of the carbon planes is larger than 0.355 nm, the potential of the negative electrode becomes 90 mV or less. That is, a change in potential occurs. Considering the fact that a battery voltage is changed due to a change in potential of the carbon-based material used in the negative electrode, if the minimum distance between layers of carbon planes of a crystalline structure of the negative electrode active material at the time of charge is larger than 0.355 nm, the battery voltage increases by about 30 mV due to the change in potential of the negative electrode, in the case where the potential of the positive electrode is flat with respect to the SOC. If the minimum distance between layers of carbon planes of a crystalline structure of the negative electrode active material at the time of discharge is smaller than 0.338 nm along a C axis length, the battery voltage decreases by about 100 mV.

Further, by controlling a minimum distance between layers of carbon planes of a carbon-based active material that is used for the negative electrode to be 0.355 to 0.338 nm, it is possible to avoid the state of overcharge as a result of an excess amount of lithium ions intercalated in the negative electrode at the time of charge. It is also possible to avoid the overdischarge at the time of discharge. Thus, a deterioration of characteristics can be reduced.

According to the above method, a change in battery voltage is measured based on a change in potential of a negative electrode material and therefore it is possible to accurately detect the SOC in controlling charge/discharge of a lithium ion secondary battery, even if an active material whose charge/discharge potential is constant is used as a positive electrode material. This means that the SOC of the battery is controlled based on a change in battery voltage even if the battery voltage does not rely on the SOC of the positive electrode potential. Accordingly, overcharge or overdischarge does not occur, and it is possible to provide highly reliable charge/discharge control method and charge/discharge control circuit using a lithium ion secondary battery, and a power supply device characterized in having the control circuit and the lithium ion secondary battery.

Embodiments of the present invention will be described in detail hereinafter, based on the drawings. In the following drawings, the structural elements having substantially the same functions are labeled with the same reference characters for brevity's sake.

In the charge/discharge control method according to an example embodiment, a change in potential of a negative electrode is detected to determine the SOC, thereby controlling charge or discharge, in a lithium ion secondary battery using a positive electrode active material whose potential is flat with respect to the SOC, i.e., whose potential does not change even if the SOC is changed. The completion of charge or the termination of discharge is also determined at this time.

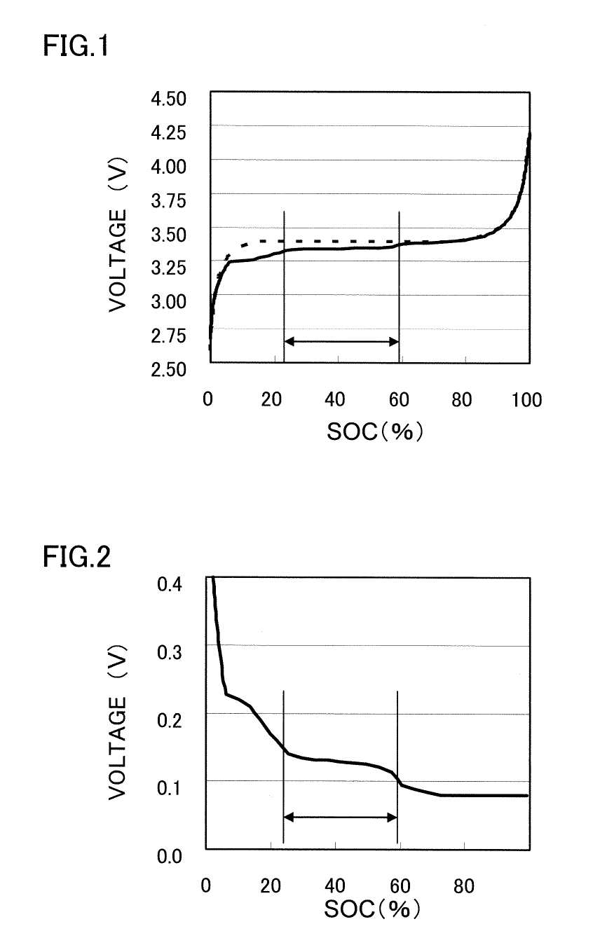

In FIG. 1, a change in battery voltage in the case of using LiFePO₄ as a positive electrode active material, and using artificial graphite as a negative electrode, is shown in solid line. A change in potential of the positive electrode made of LiFePO₄ with respect to a lithium metal electrode is shown in dotted line. FIG. 2 shows a change in potential of the negative electrode made of the artificial graphite used as the negative electrode active material of the battery shown in FIG. 1, with respect to SOC with reference to the lithium metal electrode.

In the control method according to an example embodiment, SOC is determined by detecting a change in battery voltage based on a change in potential of the negative electrode shown in FIG. 2, in the case where a change in potential of the positive electrode is flat (i.e., almost no change) with respect to the SOC like the potential of the positive electrode shown in dotted line in FIG. 1. Here, the SOC is based on the positive electrode. The SOC may be calculated based on the negative electrode.

Further, in the case where a graphite-based material is used as a material for the negative electrode, the minimum distance between layers of carbon planes are changed, and in the course of this change, the potential changes significantly with respect to the SOC. By using this change in minimum distance between layers of carbon planes, charge/discharge of a battery is controlled and completion of charge or termination of discharge is determined within a voltage range shown in FIG. 1 and FIG. 2. Here, it is preferable that the minimum distance between layers of carbon planes is in a range between 0.355 nm and 0.338 nm. If the minimum distance between layers of carbon planes is in this range, a change in impedance of the battery is flat, and a battery voltage is flat. Thus, superior output characteristics can be obtained.

In a control circuit utilizing this charge/discharge control method, the SOC of the negative electrode can be detected from a change in battery voltage during charge or discharge.

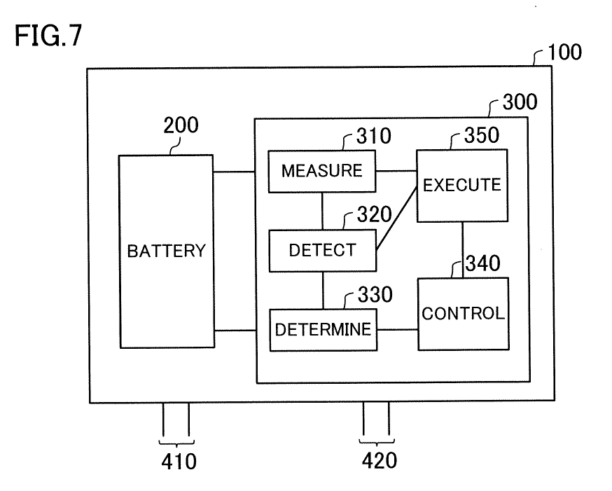

FIG. 7 shows an example structure of a mechanism of charge control and discharge control. A power supply 100 includes a lithium ion secondary battery 200 and a charge/discharge control circuit 300 (a circuit having both of the function of controlling charge and the function of controlling discharge). The charge/discharge control circuit 300 includes a voltage measurement section 310 for measuring a battery voltage, a cycle execution section 350 for performing multiple cycles, each including charge and a stop of the charge as one cycle, a voltage difference detection section 320 for detecting a voltage difference between a battery voltage measured after the stop of the charge in a cycle and a battery voltage measured after the stop of the charge in the next cycle, a determination section 330 for determining whether the voltage difference is larger or smaller than a reference voltage difference which is set, and a control section 340 for stopping the charge if the voltage difference is larger than the reference voltage difference, and for further continuing the charge if the voltage difference is equal to or smaller than the reference voltage difference. Further, the power supply 100 includes, in addition to the charge/discharge control circuit 300, a current amount control circuit (not shown) for switching between a state in which a current is output from an output terminal 410 and a state in which a current is input from an external device through an input terminal 420.

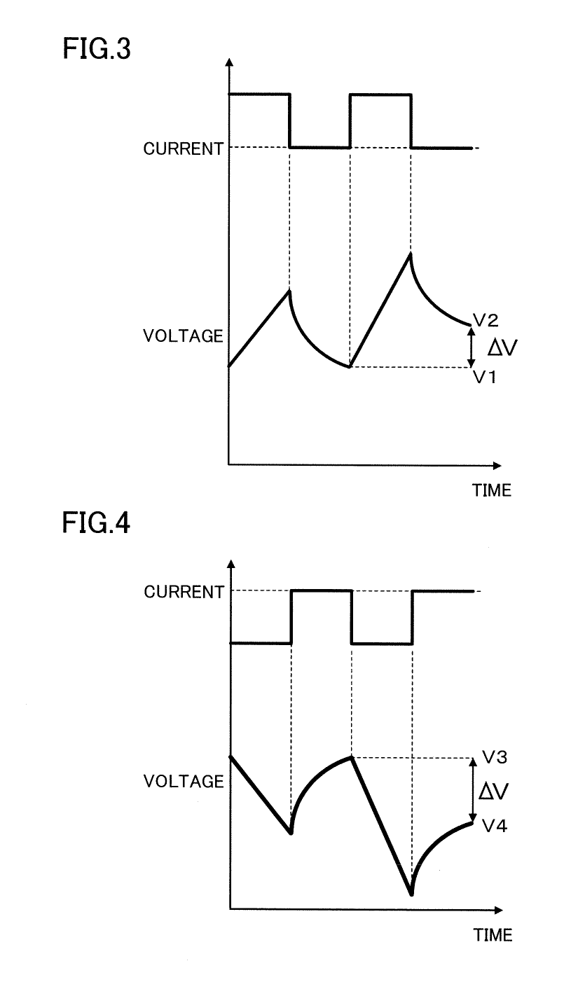

The voltage measurement section 310 can measure the voltage during charge or discharge. However, it is sometimes difficult to detect the voltage during current flow in the case where an internal resistance of the battery is high, or in the case where a charge/discharge current is large. In such a case, SOC can be detected by detecting a voltage difference at the time when no current flows after predetermined charge or discharge shown in FIG. 3 and FIG. 4.

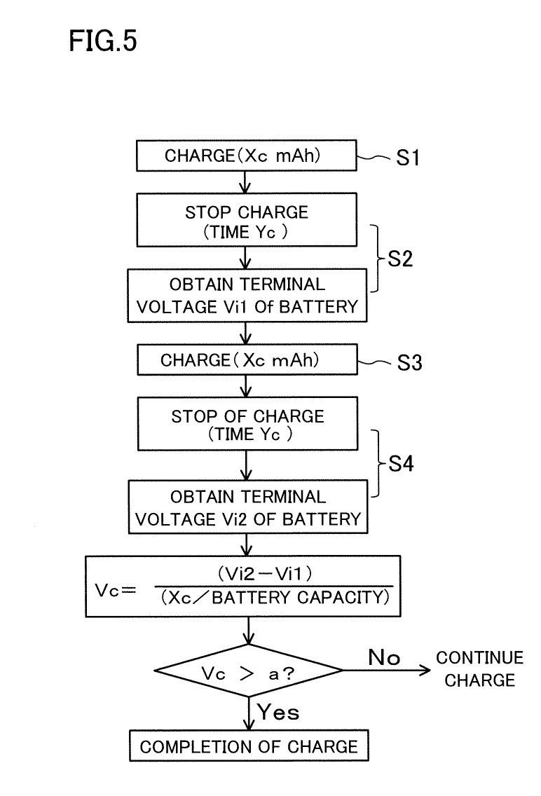

Specifically, in the case of charge as shown in FIG. 5, any amount of electricity (Xc mAh) is charged in a time Ti1 (Step S1), and after a freely determined time (Yc second) has passed since the charge was stopped, the voltage measurement section 310 measures a battery voltage (Vi1, in FIG. 3 indicated by V1) (Step S2). Then, the same amount of electricity (Xc mAh) is again charged in the time Ti1 (Step S3), and after the same time as above (Yc second) has passed since the charge was stopped, the voltage measurement section 310 measures a battery voltage (Vi2, in FIG. 3 indicated by V2) (Step S4). From the voltage difference Vi2−Vi1 (in FIG. 3 indicated by AV), an amount of change Vc normalized by the amount of charge of electricity Xc with respect to the battery capacity is calculated by the determination section 330. When the amount of change Vc becomes larger than a predetermined set value a, the determination section 330 determines that the amount of change Vc is large, and sends a signal to the control section 340. This is the completion of charge. If it is Vc≦a, the charge will be continued.

The voltage difference Vi2−Vi1 is normalized by the amount of charge of electricity Xc with respect to the battery capacity in order to sufficiently reduce an error of determination when the amount of charge of electricity Xc is changed. In the case, for example, of a regular battery for which a regular amount of charge of electricity is decided and is not changed, the determination section 330 may compare a voltage difference Vi2−Vi1 with a predetermined voltage difference Vi3 to determine completion or continuation of the charge, or in general cases, Vi3 may be calculated from a to compare with Vi2−Vi1.

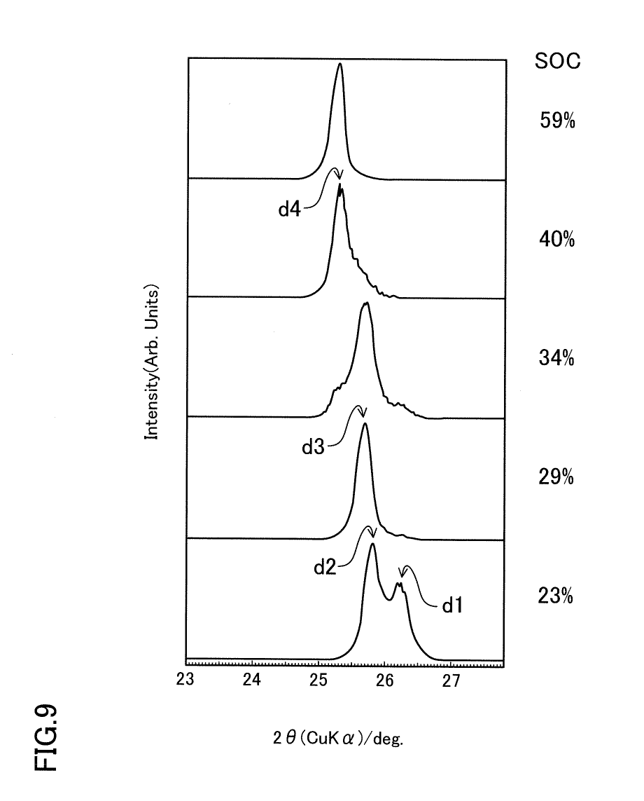

In the case where a substance having the charge/discharge characteristics shown in FIG. 2 is used as a material for the negative electrode, if a is set to an appropriate value, it is possible to check the amount of change Vc which corresponds to a voltage change at a right side of the range shown in FIG. 2 (at a portion where the SOC is slightly under 60%). The voltage change at the right side corresponds to a voltage change in the region in FIG. 9 where a distance between layers of carbon planes starts to change from 0.3523 nm (d4) to 0.3699 nm. As the SOC increases, a percentage of layers of carbon planes whose distance is 0.3699 nm increases. Specifically, “a” is preferably equal to or larger than 0.2 and smaller than 0.6, and more preferably equal to or larger than 0.3 and smaller than 0.5. The amount of charge of electricity Xc is preferably in a range between 1% and 10%, both inclusive, and more preferably in a range between 1% and 5%, both inclusive, of the battery capacity.

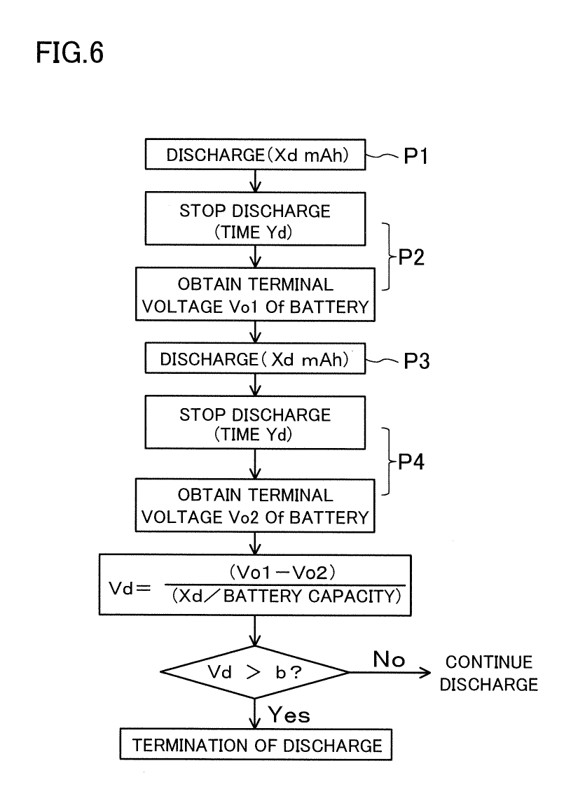

In the case of discharge, as shown in FIG. 6, any amount of electricity (Xd mAh) is discharged in a time To1 (Step P1), and after a freely determined time (Yd second) has passed since the discharge was stopped, the voltage measurement section 310 measures a battery voltage (Vo1, in FIG. 4 indicated by V3) (Step P2). Then, the same amount of electricity (Xd mAh) is again discharged in the time To1 (Step P3), and after the same time (Yd second) has passed since the discharge was stopped, the voltage measurement section 310 measures a battery voltage (Vo2, in FIG. 4 indicated by V4) (Step P4). From the voltage difference Vo1−Vo2 (in FIG. 4 indicated by AV), an amount of change Vd normalized by the amount of charge of electricity Xd with respect to the battery capacity is calculated by the determination section 330. When the amount of change Vd becomes larger than a predetermined set value b, the determination section 330 determines that the amount of change Vd is large, and sends a signal to the control section 340. This is the completion of discharge. If it is Vd≦b, the discharge will be continued.

The normalization of the voltage difference is similar to the normalization in the case of charge. For example, in the case of a regular battery for which a regular amount of discharge of electricity is decided and is not changed, the determination section 330 may compare a voltage difference Vo1−Vo2 with a predetermined voltage difference Vo3 to determine the completion or continuation of the discharge, or in general cases, Vo3 may be calculated from b to compare with Vo1−Vo2.

In the case where a substance having the charge/discharge characteristics shown in FIG. 2 is used as a material for the negative electrode, if b is set to an appropriate value, it is possible to check the amount of change Vd which corresponds to a voltage change at a left side of the range shown in FIG. 2 (at a portion where the SOC is slightly above 20%). The voltage change at the left side corresponds to a voltage change in the region in FIG. 9 where a distance between layers of carbon planes starts to change from 0.3398 nm (d1) to 0.3378 nm. As the SOC decreases, a percentage of layers of carbon planes whose distance is 0.3378 nm increases. Specifically, b is preferably equal to or larger than 0.2 and smaller than 0.8, and more preferably equal to or larger than 0.3 and smaller than 0.6. The amount of discharge of electricity Xd is preferably in a range between 0.5% and 10%, both inclusive, and more preferably in a range between 0.5% and 5%, both inclusive, of the battery capacity. In FIG. 9, d3 represents a distance of 0.3466 nm, and d2 represents a distance of 0.3448 nm, between layers of carbon planes.

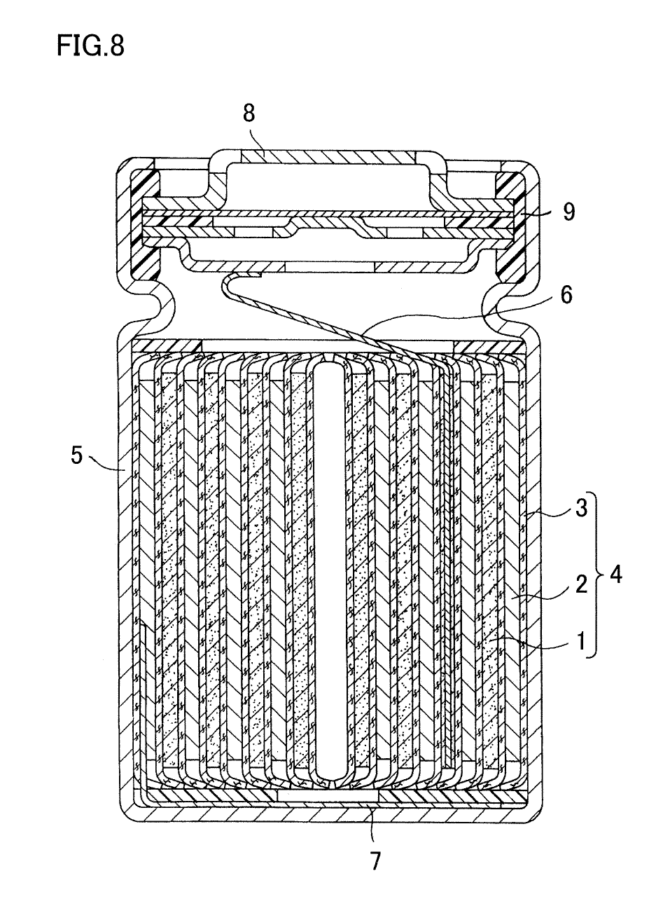

FIG. 8 shows a schematic cross section of a lithium ion secondary battery for implementing the control method of the embodiment.

As shown in FIG. 8, an electrode group 4 obtained by winding a positive electrode plate 1 and a negative electrode plate 2, with a porous insulating layer (separator) 3 interposed between the positive electrode plate 1 and the negative electrode plate 2, is sealed in a battery case 5 together with a nonaqueous electrolyte (not shown). In each of the positive electrode plate 1 and the negative electrode plate 2, a mixture layer containing an active material is formed on a surface of a current collector. The opening of the battery case 5 is sealed with a sealing plate 8 via a gasket 9. A positive electrode lead 6 attached to the positive electrode plate 1 is connected to the sealing plate 8 which also functions as a positive electrode terminal. A negative electrode lead 7 attached to the negative electrode plate 2 is connected to the bottom of the battery case 5 which also functions as a negative electrode terminal.

The structure of a lithium ion secondary battery to which the control method of the embodiment is applied is not limited to the structure shown in FIG. 8, and the control method can be applied to a rectangular lithium secondary battery, for example. Further, materials for the components of the lithium secondary battery are not specifically limited, except the materials for the positive electrode plate 1 and the negative electrode plate 2 described below. Further, the electrode group 4 may be obtained by layering the positive electrode plate 1 and the negative electrode plate 2, with a separator 3 interposed between the positive electrode plate 1 and the negative electrode plate 2.

The positive electrode plate is made of a positive electrode mixture layer including a positive electrode active material, a conductive agent, and a binder, and of a current collector. A positive electrode active material whose charge/discharge potential is flat is selected as the positive electrode active material, and it is preferable that the positive electrode active material is selected from lithium compounds having an olivine crystal structure, in particular such as LiFePO₄, LiMnPO₄, LiCoPO₄, LiCuPO₄, LiNiPO₄, and LiVPO₄, or from lithium compounds having an olivine crystal structure in which some of the transition metal elements in the above compounds are substituted with another element. If an olivine-based lithium compound is used as the positive electrode active material, a potential of the positive electrode changes little with respect to the SOC. Thus, it is possible to simplify control of a power supply using this battery.

Examples of the conductive agent include graphites such as natural graphite and artificial graphite, carbon blacks such as acetylene black, Ketchen black, channel black, furnace black, lamp black, and thermal black, conductive fibers such as carbon fiber and metal fiber, metal powders such as carbon fluoride and aluminum, conductive whiskers such as zinc oxide and potassium titanate, conductive metal oxide such as titanium oxide, and conductive organic material such as a phenylene derivative.

Examples of the binder include polyvinylidene difluoride (PVDF), polytetrafluoroethylene, polyethylene, polypropylene, aramid resin, polyamide, polyimide, polyamide imide, polyacrylonitrile, polyacrylic acid, methyl polyacrylate, ethyl polyacrylate, hexyl polyacrylate, polymethacrylic acid, methyl polymethacrylate, ethyl polymethacrylate, hexyl polymethacrylate, polyvinyl acetate, polyvinyl pyrrolidone, polyether, polyether sulfone, hexafluoropolypropylene, styrene butadiene rubber, and carboxymethyl cellulose. Further, a copolymer of two or more materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene may also be used. Two or more of the materials selected from these materials may also be mixed. Aluminum (Al), carbon, a conductive resin, etc., can be used as a material for the current collector. Any of these materials may be surface treated with carbon, for example.

The negative electrode plate is made of a negative electrode mixture layer including a negative electrode active material, a conductive agent, and a binder, and of a current collector. A material in which lithium ions can be inserted and from which the lithium ions can be extracted, and of which a charge/discharge potential is variable is good as the negative electrode active material. Specifically, a graphite material is suitable, and graphite, amorphous carbon, etc., are preferable. A graphite material changes in stages due to insertion and extraction of lithium ions at the time of charge and discharge, and a charge/discharge potential changes in stages as shown in FIG. 2. Thus, even if the charge/discharge potential of the positive electrode is flat as shown in FIG. 1, the charge/discharge voltage is changed by the negative electrode active material as shown in the battery voltage of FIG. 1. Therefore, it is possible to detect the SOC by measuring the voltage change. Further, within a range of control of charge and discharge, the graphite material to be used as the negative electrode is preferably such that a minimum distance between layers of carbon planes is in a range of 0.355 nm to 0.338 nm. If the distance between layers of carbon planes is in this range, the charge/discharge voltage of the lithium ion secondary battery is almost constant, and a potential of the negative electrode is significantly changed in a region having a crystalline structure other than the above crystalline structure. Thus, the SOC can be determined by detecting this change The amount of lithium ions does not exceed the amount of lithium ions which can be intercalated in carbon at the time of charge (insertion of lithium ions), and the state in which lithium remains in the carbon can be maintained at the time of discharge (extraction of the lithium ions). Accordingly, a deterioration of the battery's characteristics due to overcharge or overdischarge can be reduced.

Examples of the current collector include metallic foils made of such as stainless steel, nickel, copper and titanium, and thin films made of such as carbon and conductive resin.

Examples of the binder include polyvinylidene difluoride (PVDF), polytetrafluoroethylene, polyethylene, polypropylene, aramid resin, polyamide, polyimide, polyamide imide, polyacrylonitrile, polyacrylic acid, methyl polyacrylate, ethyl polyacrylate, hexyl polyacrylate, polymethacrylic acid, methyl polymethacrylate, ethyl polymethacrylate, hexyl polymethacrylate, polyvinyl acetate, polyvinyl pyrrolidone, polyether, polyether sulfone, hexafluoropolypropylene, styrene butadiene rubber, and carboxymethyl cellulose. Further, a copolymer of two or more materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene may also be used. Further, as necessary, a conductive agent, for example, graphites such as flake-like graphite including natural graphite, artificial graphite, and expanded graphite, carbon blacks such as acetylene black, Ketchen black, channel black, furnace black, lamp black, and thermal black, conductive fibers such as carbon fiber and metal fiber, metallic powders such as copper and nickel, an organic conductive material such as a polyphenylene derivative, may be mixed with the negative electrode mixture layer. Further, as a nonaqueous electrolyte (not shown), an electrolyte solution prepared by dissolving a solute in an organic solvent, and a so-called polymeric electrolyte layer in which the nonaqueous electrolyte solution is contained, and is immobilized by a polymer can be used.

When at least the electrolyte solution is used, a separator 3 made of nonwoven fabric or a microporous film made of polyethylene, polypropylene, aramid resin, amideimide, polyphenylene sulfide, polyimide, etc., is provided between the positive electrode 2 and the negative electrode 1, and the separator 3 is preferably impregnated with the electrolyte solution. A heat resistant filler such as alumina, magnesia, silica, titania, etc., may be provided inside or on the surface of the separator 3. A heat resistant layer made of the filler and a binder similar to that used in the positive electrode 2 and the negative electrode 1 may be provided separately from the separator 3. The material for the nonaqueous electrolyte is selected based on oxidation-reduction potentials of the positive electrode active material and negative electrode active material. The solute preferably used for the nonaqueous electrolyte may be salts generally used in the lithium batteries, for example, LiPF₆, LiBF₄, LiN(CF₃CO₂), LiClO₄, LiAlCl₄, LiSbF₆, LiSCN, LiCF₃SO₃, LiN(CF₃SO₂)₂, LiAsF₆, LiB₁₀Cl₁₀, lower aliphatic lithium carboxylate, LiF, LiCl, LiBr, LiI, chloroborane lithium, borates such as bis(1,2-benzendiolate(2-)-O,O′)lithium borate, bis(2,3-naphthalene diolate(2-)-O,O′)lithium borate, bis(2,2′-biphenyldiolate(2-)-O,O′)lithium borate, bis(5-fluoro-2-olate-1-benzenesulfonic acid-O,O′)lithium borate, and (CF₃SO₂)₂NLi, LiN(CF₃SO₂)(C₄F₉SO₂), (C₂F₅SO₂)₂NLi, and lithium tetraphenylborate.

The organic solvent for dissolving the salts may be a solvent generally used in the lithium batteries, for example, one of the following materials, or a compound of more than one of the following materials including ethylene carbonate (EC), propylene carbonate, butylene carbonate, vinylene carbonate, dimethyl carbonate (DMC), diethyl carbonate, ethyl methyl carbonate (EMC), dipropyl carbonate, methyl formate, methyl acetate, methyl propionate, ethyl propionate, dimethoxyethane, γ-butyrolactone, γ-valerolactone, 1,2-diethoxyethane, 1,2-dimethoxyethane, ethoxymethoxyethane, trimethoxymethane, tetrahydrofuran derivatives such as tetrahydrofuran, 2-methyl tetrahydrofuran, etc., dimethyl sulfoxide, dioxolane derivatives such as 1,3-dioxolane, 4-methyl-1,3-dioxolane, etc., formamide, acetoamide, dimetyl formamide, acetonitrile, propylnitrile, nitromethane, ethyl monoglyme, phosphoric acid triester, acetate, propionate, sulfolane, 3-methyl sulfolane, 1,3-dimethyl-2-imidazolidinone, 3-methyl-2-oxazolidinone, propylene carbonate derivatives, ethyl ether, diethyl ether, 1,3-propane sultone, anisole, fluorobenzene, etc.

The organic solvent may further contain an additive such as vinylene carbonate, cyclohexylbenzene, biphenyl, diphenyl ether, vinyl ethylene carbonate, divinyl ethylene carbonate, phenyl ethylene carbonate, diallyl carbonate, fluoroethylene carbonate, catechol carbonate, vinyl acetate, ethylene sulfate, propane sultone, trifluoropropylene carbonate, dibenzofuran, 2,4-difluoroanisole, o-terphenyl, m-terphenyl, etc.

The nonaqueous electrolyte may be a solid electrolyte prepared by mixing the above-described solute with one of the following polymeric materials, or a mixture of more than one of the polymeric materials including polyethylene oxide, polypropylene oxide, polyphosphazene, polyaziridine, polyethylene sulfide, polyvinyl alcohol, polyvinylidene fluoride, polyhexafluoropropylene, etc. The nonaqueous electrolyte may be a gelled nonaqueous electrolyte prepared by mixing the solute with the above-described organic solvent. Further, the nonaqueous electrolyte may be a solid electrolyte made of an inorganic material such as lithium nitride, lithium halide, lithium oxysalt, Li₄SiO₄—LiI—LiOH,, Li₃PO₄—Li₄SiO₄, Li₂SiS₃, Li₃PO₄—Li₂S—SiS₂, a phosphorus sulfide compound, etc.

### EXAMPLE

In the positive electrode plate 1, an aluminum foil (having a thickness of 15 μm) was used as the positive electrode current collector, and LiFePO₄ (fabricated by Mitsui Engineering & Shipbuilding Co., Ltd.) was used as the positive electrode active material. In the negative electrode plate 2, an electrolytic copper foil (having a thickness of 8 μm) was used as negative electrode current collector, and artificial graphite (by Mitsubishi Chemical Corporation) was used as the negative electrode active material. LiPF₆ was used as a nonaqueous electrolyte.

The minimum distance between layers of carbon planes was measured by X-ray diffraction. The measurement device used was X'Pert (fabricated by Philips). As an X-ray for measurement, a CuKαX-ray with a wavelength of 0.154 nm was used. A measurement range of 2θ was set to a range from 10.0° to 40.0°, and a measurement was conducted at a step of 0.02°. The measurement was performed in an Ar airflow so that a sample would not be exposed to the air.

The minimum distance between layers of carbon planes was obtained from the diffraction angle 2θ of a diffraction peak which appeared in a range of 23° to 27° measured by the X-ray diffraction. A range of from 0.355 nm to 0.338 nm of the distance between layers of carbon planes corresponds to a range of from 25.05° to 26.33° of the diffraction angle 2θ.

The minimum distance between layers of carbon planes d (nm) was calculated using Bragg equation

d=(0.154/2)×(1/sin(2θ/2))

The obtained battery was charged to the SOC of 50% at 1000 mA for 30 minutes. The charge voltage during the charge at 100 mA was shown in FIG. 1. At the SOC of 100%, the amount of charge of electricity was 1000 mAh.

After that, using the charge/discharge control circuit shown in FIG. 7, the battery was charged at 1000 mA for one minute (the amount of charge of electricity is 1000/60 mAh), and the charge was stopped for one minute. Then, a battery voltage (Vi1) was measured. Subsequently, the battery was charged at 1000 mA for one minute, and thereafter the charge was stopped for one minute. Then, a battery voltage (Vi2) was measured. This operation was continued, and was controlled under the condition that the charge would be completed when Vc calculated by the equation of Vc=(Vi2−Vi1)/(60 mAh/1000 mAh) exceeded 0.30.

The equation became Vc=(3.371 V−3.352 V)/(60 mAh/1000 mAh)=0.32>0.30 at some point in the course of the charge operation, and thus, completion of charge was determined. The SOC at this time was 59%. Further, it was found from a result of X-ray diffraction of the carbon of the negative electrode in this state, that the minimum distance between layers of carbon planes was d4=0.3523 nm, and also that the battery was not charged to the minimum distance between layers of carbon planes of 0.369 nm at which a maximum amount of lithium ions is inserted in the carbon, as shown in FIG. 9.

Then, conditions of discharge were checked. The above battery was charged to the SOC of 50%, and was discharged at 1000 mA for one minute (the amount of discharge of electricity is 1000/60 mAh) using the charge/discharge control circuit shown in FIG. 7, and the discharge was stopped for one minute. Then, a battery voltage (Vo1) was measured. Subsequently, the battery was discharged at 1000 mA for one minute, and thereafter the discharge was stopped for one minute. Then, a battery voltage (Vo2) was measured. This operation was continued, and was controlled under the condition that the discharge would be stopped when Vd calculated by the equation of Vd=(Vo1−Vo2)/(60 mAh/1000 mAh) exceeded 0.50.

The equation became Vd=(3.342 V−3.309 V)/(60 mAh/1000 mAh)=0.55>0.50 at some point in the course of the operation, and thus, the discharge was stopped. The SOC at this time was 23%. Further, it was found from a result of X-ray diffraction of the carbon of the negative electrode in this state, that the minimum distance between layers of carbon planes was d1=0.3398 nm shown in FIG. 9, and also that the battery was not discharged to the minimum distance between layers of carbon planes of 0.335 nm at which no lithium ions at all is inserted in the carbon.

By controlling charge and discharge using the above power supply, the control circuit, etc., and the above method, it is possible to use a lithium ion secondary battery in the SOC range of from 23% to 59%. Since the battery is used in a range which ensures the battery performance, the battery can be in a stable condition (a condition in which the battery capacity does not change) for a long time. In particular, if a lithium ion secondary battery is used in the SOC range of nearly 0% or nearly 100%, overcharge or overdischarge may locally occur in part of the battery, and the battery may be deteriorated. However, the battery is not deteriorated if the above power supply, the control circuit, etc., and the above method are used.

### Other Embodiments

The above embodiment is an example of the present invention, and the present invention is not limited to this example. For example, the above method may be combined with control in which the state of charge and the state of discharge are checked every predetermined time, or the above method may be combined with control in which the state of charge and the state of discharge are checked immediately before use or immediately after use of a power supply. The size, the number, etc., of the lithium ion secondary battery are not specifically limited.

Further, the amount of insertion and extraction of lithium of the positive electrode, and the amount of insertion and extraction of lithium of the negative electrode can be decided by an amount of lithium ions stored in the secondary battery. If the storage rate in the positive electrode and the negative electrode is adjusted such that the minimum distance between layers of carbon planes is equal to or smaller than 0.3523 nm by adjusting the amount of the negative electrode to prevent overcharge of the positive electrode, it is possible to design a battery, while maximizing the use range of a positive electrode.

A lithium secondary battery whose rated capacity is 1000 mAh was described as an example in the above embodiment. However, the present invention can also be applied to lithium secondary batteries whose rated capacity is other than 1000 mAh.

### INDUSTRIAL APPLICABILITY

The present invention can be advantageously utilized in vehicles such as electric vehicles and hybrid vehicles, and battery mounting devices such as power supply systems in which a secondary battery is combined with a solar battery or an electric power generating system.

### DESCRIPTION OF REFERENCE CHARACTERS

1 positive electrode plate

2 negative electrode plate

3 porous insulating layer (separator)

4 electrode group

5 battery case

6 positive electrode lead

7 negative electrode lead

8 sealing plate

9 gasket

100 power supply

200 lithium ion secondary battery

300 charge/discharge control circuit

310 voltage measurement section

320 voltage difference detection section

330 determination section

340 control section

350 cycle execution section

1. A method for determining completion of charge of a lithium ion secondary battery including one lithium compound having an olivine crystal structure as a positive electrode active material, and a graphite material as a negative electrode active material, the method comprising:
(S1) charging the battery by an amount of electricity Xc in time Ti1;
(S2) stopping the charging for time Yc after completion of (S1), and measuring a battery voltage Vi1 after the time Yc has passed;
(S3) charging the battery by the amount of electricity Xc in the time Ti1 after completion of (S2);
(S4) stopping the charging for the time Yc after completion of (S3), and measuring a battery voltage Vi2 after the time Yc has passed; and
comparing Vi2−Vi1 with a predetermined voltage difference Vi3 to determine that the charge has been completed when Vi2−Vi1>Vi3, or determine that the charge has not been completed when Vi2−Vi1<Vi3.

2. The method for determining completion of charge of the lithium ion secondary battery of claim 1, wherein
a minimum distance between layers of carbon planes of the graphite material is equal to or smaller than 0.355 nm when it is determined that the charge has been completed.

3. A method for determining termination of discharge of a lithium ion secondary battery including one lithium compound having an olivine crystal structure as a positive electrode active material, and a graphite material as a negative electrode active material, the method comprising:
(P1) discharging the battery by an amount of electricity Xd in time To1;
(P2) stopping the discharging for time Yd after completion of (P1), and measuring a battery voltage Vo1 after the time Yd has passed;
(P3) discharging the battery by the amount of electricity Xd in the time To1 after completion of (P2);
(P4) stopping the discharging for the time Yd after completion of (P3), and measuring a battery voltage Vo2 after the time Yd has passed; and
comparing Vo1−Vo2 with a predetermined voltage difference Vo3 to determine that the discharge has been terminated when Vo1−Vo2>Vo3, or determine that the discharge has not been terminated when Vo1−Vo2≦Vo3.

4. The method for determining termination of discharge of the lithium ion secondary battery of claim 3, wherein
a minimum distance between layers of carbon planes of the graphite material is equal to or larger than 0.338 nm when it is determined that the discharge has been terminated.

5. A charge control circuit for a lithium ion secondary battery including one lithium compound having an olivine crystal structure as a positive electrode active material, and a graphite material as a negative electrode active material, the charge control circuit comprising:
a voltage measurement section for measuring a battery voltage;
a cycle execution section for performing multiple cycles, each cycle including charge and a stop of the charge as one cycle;
a voltage difference detection section for detecting a difference between a battery voltage after a stop of charge of one of the cycles and a battery voltage after a stop of charge of a cycle subsequent to the one of the cycles;
a determination section for determining whether the voltage difference detected by the voltage difference detection section is larger or smaller than a set value; and
a control section for stopping the charge when the voltage difference is larger than the set value, and continuing the charge when the voltage difference is smaller than the set value.

6. The charge control circuit of claim 5, wherein
the control section controls the charge such that a minimum distance between layers of carbon planes of the graphite material is equal to or smaller than 0.355 nm.

7. A discharge control circuit for a lithium ion secondary battery including one lithium compound having an olivine crystal structure as a positive electrode active material, and a graphite material as a negative electrode active material, the discharge control circuit comprising:
a voltage measurement section for measuring a battery voltage;
a cycle execution section for performing multiple cycles, each cycle including discharge and a stop of the discharge as one cycle;
a voltage difference detection section for detecting a difference between a battery voltage after a stop of discharge of one of the cycles and a battery voltage after a stop of discharge of a cycle subsequent to the one of the cycles;
a determination section for determining whether the voltage difference detected by the voltage difference detection section is larger or smaller than a set value; and
a control section for stopping the discharge when the voltage difference is larger than the set value, and continuing the discharge when the voltage difference is smaller than the set value.

8. The discharge control circuit of claim 7, wherein
the control section controls the discharge such that a minimum distance between layers of carbon planes of the graphite material is equal to or larger than 0.338 nm.

9. A power supply, comprising:
a lithium ion secondary battery including one lithium compound having an olivine crystal structure as a positive electrode active material, and a graphite material as a negative electrode active material; and
at least one of the charge control circuit of claim 5 or claim 6, or the discharge control circuit of claim 7 or claim 8.

10. The power supply of claim 9, wherein
the lithium compound is any one of LiFePO₄, LiMnPO₄, LiCoPO₄, LiCuPO₄, LiNiPO₄, LiVPO₄, or a lithium compound having an olivine crystal structure in which some of transition metal elements of the LiFePO₄, LiMnPO₄, LiCoPO₄, LiCuPO₄, LiNiPO₄, LiVPO₄ are substituted with another element.
